(19) United States
(12) Patent Application Publication
(10) Pub. No.: US 2015/0274577 A1
(43) Pub. Date: Oct. 1, 2015

(54) METHOD FOR MANUFACTURING MULTI-CORE OPTICAL FIBER

(71) Applicant: SUMITOMO ELECTRIC INDUSTRIES, LTD., Osaka (JP)

(72) Inventors: Tetsuya NAKANISHI, Yokohama-shi (JP); Takashi SASAKI, Yokohama-shi (JP)

(21) Appl. No.: 14/662,508

(22) Filed: Mar. 19, 2015

(30) Foreign Application Priority Data
Mar. 31, 2014 (JP) 2014-073217

(51) Int. Cl. C03B 37/012; G02B 6/255; C03B 37/025; G02B 6/02

(52) U.S. Cl. CPC C03B 37/01222; G02B 6/02042; G02B 6/255; C03B 37/025; C03B 37/0253; C03B 2203/34

(57) ABSTRACT

A manufacturing method according to an embodiment of the invention includes a step of calculating Pj_{0.1} satisfying (62.6×J_{OH}+1175)×Pj=0.1, where Pj is an optical power ratio at the wavelength 1383 nm of a portion corresponding to a cladding material of an MCF after drawn, and an outer diameter ratio P_{cc0.1} of core portions to core rods to obtain Pj_{0.1}. The core rods have an outer diameter 2R_{0.1} satisfying the condition that a ratio P_{cc} is not less than the ratio P_{cc0.1}, and the cladding material has holes formed in a diameter larger by C (not less than 0.15 mm and not more than 1.5 mm) than the outer diameter of the core rods.

### BACKGROUND OF THE INVENTION

1. Field of the Invention

The present invention relates to a method for manufacturing a multi-core optical fiber.

2. Related Background Art

Japanese Patent No. 5176274 (Patent Literature 1) discloses a Rod-In Drawing method (hereinafter referred to as “RID method”) for producing a Single Core Fiber (hereinafter referred to as “SCF”) by drawing. In this RID method, the SCF is produced by inserting a core into a pipe of a cladding material having a hole at a center only and arranging this cladding material in the vertical direction. Then, the pipe is guided into a drawing furnace and drawn into fiber while heated to integrate. This RID method has a step of removing water for the core rod and the interior surface of the cladding pipe, after the insertion of the core into the cladding pipe; a step of sealing at least one end of the cladding pipe; and a step of drawing the pipe from one end into optical fiber while connecting the gap between the core rod and cladding pipe to a dry gas atmosphere or depressurizing the gap.

### SUMMARY OF THE INVENTION

In producing the SCF by use of the RID method, the core insertion hole is not collapsed at the preform stage and, since the hole is present only at the center of the cladding material, there is an action to bring the core closer to the preform center during a collapsing and thus it is easy to control an amount of eccentricity of the core in the drawn optical fiber within a certain level. It was believed on the other hand that, in producing a Multi-Core optical Fiber (hereinafter referred to as “MCF”) by use of the RID method, since the core insertion holes were not collapsed at the preform stage and there were the holes other than that at the center of the cladding material, each core was not always brought closer to the center of each hole and it was disadvantageous in achieving higher accuracy of core arrangement in a cross section. For this reason, it was difficult to manufacture the MCF by use of the RID method. Particularly, there is no known method capable of manufacturing the MCF while achieving satisfactory core position accuracy, transmission loss, and mass productivity all together by use of the RID method; for this reason, in the conventional manufacture of MCF, the core arrangement positions were once fixed at the preform stage for MCF by the Rod-In Collapse method (hereinafter referred to as “RIC method”), the core positions were corrected by periphery grinding or the like if needed, and, thereafter, the pipe was drawn by ordinary fiber drawing to obtain optical fiber.

The MCF desirably has small variation from predetermined core positions, in order to ensure good mutual connectivity. The need for higher accuracy of core arrangement positions is a particular problem to the MCF and an increase in splice loss will occur unless the core positions are accurately arranged where all the cores are optically connected in a lump, in optically splicing two MCFs or in optically splicing the MCF to a light receiving device or to a light emitting device. For improving the accuracy of core positions, it is necessary to decrease an error of the position of each core in the hole in a rod-in state. If in the RID method there is a large difference (clearance) between the outer diameter of each core rod and the inner diameter of the corresponding hole in the cladding material, the core rod will be able to move by a large amount in the hole of the cladding material, so as to cause occurrence of variation in core position in the manufactured MCF; therefore, the clearance is preferably as small as possible.

Furthermore, there are the cores (satellite cores, e.g., cf. cores 4a in FIG. 2B) except for that at the center of the cladding material in the core preform for MCF. A ratio of the outer diameter of the cladding material to the distance from the satellite core part to the outermost periphery of the cladding material becomes larger than a ratio of the outer diameter of the cladding material to the center core part of SCF. Therefore, when a dummy pipe is spliced to the preform in the same size, the dummy pipe becomes thinner in the case of MCF. The thinning of the dummy pipe leads to a decrease in strength of the spliced part. On the other hand, if the area of the spliced part is increased, the area of the cladding portion will increase by that degree, resulting in unwanted increase of the fiber diameter of MCF.

As described above, the method of manufacturing the MCF by use of the RID method had the problems of the limitation to decrease of thickness of the dummy pipe, degradation of core position accuracy, and increase in transmission loss due to residual OH groups, when compared to the SCF case.

Then, the Inventors came to consider that it must be effective to decrease the hole diameter for all the cores including the satellite cores, as means for avoiding the decrease of thickness of the dummy pipe. This means that the thickness of the dummy pipe can be increased by the degree of the decrease of the hole diameter. However, the core material to be inserted into each hole is composed of a core rod having a core portion and a cladding portion (partial cladding) to form a part of the cladding. By decreasing the thickness of this cladding portion, the hole diameter can be decreased. However, if this cladding portion is made too thin, it will result in increase of quantity of light leaking from the core rods to the cladding material, leading to increase in transmission loss due to OH groups contained in the cladding material.

The present invention aims to solve the problems as described above. For solving the foregoing problems, the Inventors focused attention on the point that the above problems should be solved by appropriately setting the thickness of the cladding portion in the core rod, depending upon an amount of OH groups contained in the cladding material.

Another particular problem to the MCF is a problem of a need for securing the position accuracy of the satellite cores. As for the positions of the satellite cores, there is not only the problem of the positions of the holes but also a problem of position accuracy in collapse of the holes during the drawing, as a phenomenon peculiar to the RID method. As a countermeasure for it, the diameter of the core rods can be decreased and then the hole diameter can also be decreased, whereby it becomes easier to ensure the core position accuracy by that degree. The decrease of the hole diameter is also preferable in terms of measures against the decrease of the diameter of the dummy pipe. However, since the decrease of the core rod diameter also leads to decrease of the thickness of the cladding covering the cores, it was disadvantageous from the aspect of increase in transmission loss in the portion where light leaks from the core rods into the cladding.

In forming the holes in a plurality of cladding materials, cracks become more likely to be generated in interspaces present between holes. Although it depends on the material, composition, and residual stress due to heat history of glass, a generation rate of cracks tends to increase with decrease in thickness of the interspaces and, in the case of general synthetic silica, the thickness of the interspaces is preferably not less than 1 mm. The decrease of the hole diameter in the cladding material is thus significant in this respect.

As shown in FIG. 13 of Patent Literature 1, when the SCF is manufactured by use of the RID method, the position of the hole in the cladding material is only the center on the axis and thus the inserted core rod can be brought into a butt against the dummy pipe by heating a part of the spliced dummy pipe so as to slightly reduce the diameter. At this time, a dip is preliminarily made on the outer periphery of the core rod in a contact portion between the core rod and the dummy pipe and the core rod is processed in a shape to make a clearance of the dip in the contact portion, whereby the core rod can be fixed as prevented from dropping, while securing a flow path of gas. This allows us to perform a purifying process in vapor phase by heating under a flow of halogen gas or the like between the inner wall of the hole in the cladding material and the outer periphery of the core rod. After the purifying process, the dummy pipe part on the drawing start end side is extended on heating, thereby to integrate and seal the dummy pipe and the core, and, while keeping the pressure between the core rod and the hole of the cladding material at a negative pressure by a pressure regulating mechanism connected to the top of the cladding material, the drawing process is conducted by heating to integrate them, thereby obtaining the optical fiber with a low transmission loss, free of impurities at the interface between the core rod and the hole in the cladding material.

On the other hand, when the MCF is manufactured by use of the RID method, there are the positions of the holes in the cladding material except for the center on the axis and, therefore, when the diameter of the spliced dummy pipe is reduced in part, the core rods on the peripheral side can be brought into a butt against the diameter-reduced part of the dummy pipe but the core rod on the center side cannot be brought into a butt against it. A long process time is needed for reducing the diameter of the dummy pipe to one enough to bring the core rod on the center side into a butt against it. Since the thickness of the dummy pipe becomes smaller relative to the outer diameter in the case of MCF, as described previously, the dummy pipe is likely to become noncircular in the diameter reduction process and it is thus difficult to control the outer diameter; therefore, it was difficult to perform the diameter reduction process to a predetermined outer diameter, per se. For this reason, it was difficult to secure the flow path of gas while fixing the cores at predetermined positions so as to prevent them from dropping, or, it was necessary to use a core fixing member to secure the flow path of gas while preventing the cores from dropping. For the above reasons, the manufacturing method of the MCF by use of the RID method had the problems that it was difficult to perform the purifying process in vapor phase between the inner walls of the holes of the cladding material and the outer peripheries of the core rods and that it was difficult to obtain the optical fiber with a low transmission loss, free of impurities at the interfaces between the core rods and the holes in the cladding material, while achieving satisfactory economic efficiency and productivity together.

The present invention has been accomplished in order to solve the above problems and it is an object of the present invention to provide a method for manufacturing an MCF (multi-core optical fiber) with excellent economic efficiency and productivity and with a low transmission loss.

A method for manufacturing an MCF according to one aspect of the present invention comprises a cladding material preparing step, a core rod producing step, a hole making step, a splicing step, and a drawing step. The cladding material preparing step is a step of preparing a cladding material comprised of silica-based glass and having an average concentration J_{OH} of OH groups less than a predetermined concentration. The core rod producing step is a step of producing a plurality of core rods comprised of silica-based glass and each having a core portion and a part of a cladding. The hole making step is a step of making a plurality of holes in the cladding material so as to extend along an axial direction thereof. The splicing step is a step of splicing a dummy pipe to a first end side of the cladding material. The inserting step is a step subsequent to the splicing step, and this inserting step is a step of inserting the plurality of core rods into the respective holes in the cladding material. The drawing step is a step subsequent to the inserting step, and this drawing step is a step of integrating the cladding material and the core rods and drawing a thus-integrated part thereof while heating a second end side of the cladding material, thereby drawing the cladding material and the core rods into the MCF. Particularly, an average concentration of OH groups in each of the core rods prepared is less than 0.001 weight ppm and J_{OH} is less than 100 weight ppm. The manufacturing method of the MCF comprises: a Pj calculating step of calculating PJ_{0.1} (Pj in the case of X=0.1) satisfying X=(62.6×J_{OH} (weight ppm)+1175)×Pj=0.1, where Pj is an optical power ratio at the wavelength 1383 nm of a portion corresponding to the cladding material in the MCF after drawn; and a P_{cc} calculating step of calculating P_{cc0.1} (P_{cc} in the case of X=0.1) to obtain Pj_{0.1} that can be calculated based on a core-rod refractive index profile, where P_{cc} is a ratio of an outer diameter of the core rods to an outer diameter of the core portions (the outer diameter of the core rods/the outer diameter of the core portions). The core rod producing step comprises processing the core rods so as to satisfy the condition that the ratio P_{cc} is not less than the ratio P_{cc0.1} and so as to make each of the core rods have a core rod diameter 2R_{0.1} (2R in the case of P_{cc}≧P_{0.1}), where 2R is the outer diameter of the core rods whose core portions are configured so that a predetermined relation in the MCF after drawn, between an outer diameter thereof and an outer diameter of cores corresponds to a relation between the outer diameter of the cladding material and the outer diameter of the core portions. The hole making step comprises processing the plurality of holes in a range where C is not less than 0.15 mm and not more than 1.5 mm, where a hole diameter of the plurality of holes formed in the cladding material is set to the core rod diameter 2R_{0.1}+C.

### BRIEF DESCRIPTION OF THE DRAWINGS

FIG. 1 is a drawing showing a configuration of a drawing device to which the method for manufacturing the MCF according to one embodiment of the present invention is applied.

FIG. 2A is a cross-sectional view showing a spliced part between a cladding material and a dummy pipe and a spliced part between the cladding material and a sealing member and FIG. 2B a drawing for explaining a relation among diameters on a splice plane between the cladding material and the dummy pipe.

FIG. 3 is a flowchart for explaining the method for manufacturing the MCF according to one embodiment of the present invention.

FIG. 4 is a drawing showing increase of transmission loss at the wavelength 1383 nm against power fraction Pj.

FIG. 5 is a drawing showing radius dependence of refractive index profile and optical power.

FIG. 6 is a drawing showing a relation between average concentration of OH groups in the cladding material and X value in Formula (1).

### DETAILED DESCRIPTION OF EMBODIMENTS

### Description of Aspects of Embodiment of Invention

Aspects of the embodiment of the invention will be first described as enumerated below.

(1) A method for manufacturing an MCF (multi-core optical fiber) according to a first aspect of the embodiment of the invention is a method comprising: a cladding material preparing step of preparing a cladding material comprised of silica-based glass and having an average concentration J_{OH} of OH groups less than a predetermined concentration; a core rod producing step of producing a plurality of core rods comprised of silica-based glass and each having a core portion and a part of a cladding; a hole making step of making a plurality of holes in the cladding material so as to extend along an axial direction thereof; a splicing step of splicing a dummy pipe to a first end side of the cladding material; an inserting step subsequent to the splicing step, the inserting step being a step of inserting the plurality of core rods into the respective holes in the cladding material; and a drawing step subsequent to the inserting step, the drawing step being a step of, while heating a second end side of the cladding material so as to integrate the cladding material and the core rods, drawing a thus-integrated part thereof from the second end side so as to implement drawing into the MCF, wherein an average concentration of OH groups in the core rods prepared is less than 0.001 weight ppm and the average concentration J_{OH} of OH groups in the cladding material is less than 100 weight ppm, the method further comprising: a Pj calculating step of calculating Pj_{0.1} (Pj in the case of X=0.1) satisfying X=(62.6×J_{OH} (weight ppm)+1175)×Pj=0.1, where Pj is an optical power ratio at the wavelength 1383 nm of a portion (part other than the core rods) corresponding to the cladding material in the optical fiber (MCF) after drawn in the drawing step; and a P_{cc} calculating step of calculating P_{cc0.1} (P_{cc} in the case of X=0.1) to obtain the Pj_{0.1} that can be calculated based on a refractive index profile of the core rods, where P_{cc} is a ratio of an outer diameter of the core rods to an outer diameter of the core portions (the outer diameter of the core rods/the diameter of the core portions), wherein the core rod producing step comprises processing the core rods so as to satisfy the condition that the ratio P_{cc} is not less than the ratio P_{cc0.1} and so as to make each of the core rods have a core rod diameter 2R_{0.1}, where 2R is the core rod diameter in the condition that the core portions of the core rods are configured so that a relation between a predetermined outer diameter of the optical fiber after drawn and a predetermined core diameter corresponds to a relation between the outer diameter of the cladding material and the diameter of the core portions of the core rods, and wherein the hole making step comprises processing the plurality of holes in a range where a clearance C is not less than 0.15 mm and not more than 1.5 mm, where a hole diameter of the plurality of holes formed in the cladding material is set to the core rod diameter 2R_{0.1}+C.

In the foregoing manufacturing method as described above, the core rods are produced so as to have the predetermined core rod diameter with the use of J_{OH} indicative of the average concentration of OH groups in the cladding material and the optical power ratio Pj of the part other than the core rods in the optical fiber and the holes for arrangement of the core rods are processed so that the clearance C to the core rod diameter as defined is not less than 0.15 mm and not more than 1.5 mm. For this reason, the foregoing manufacturing method can appropriately set the thickness of the cladding portions in the core rods while controlling the increase of transmission loss at the wavelength 1383 nm due to OH groups present on the outer peripheries of the core rods, to not more than 0.1 dB/km. Since in the foregoing manufacturing method the clearance C is not less than 0.15 mm, it can prevent the core rods from scraping the inner surfaces of the holes during insertion and thereby generating scratches on the inner surfaces of the holes in the cladding material and on the outer peripheral surfaces of the core rods. Since the clearance C is not more than 1.5 mm, it can achieve high accuracy of the core positions in the MCF and can also suppress longitudinal variation of the core positions. The foregoing allows the manufacturing method to manufacture the MCF while achieving satisfactory transmission loss, core position accuracy, and mass productivity all together.

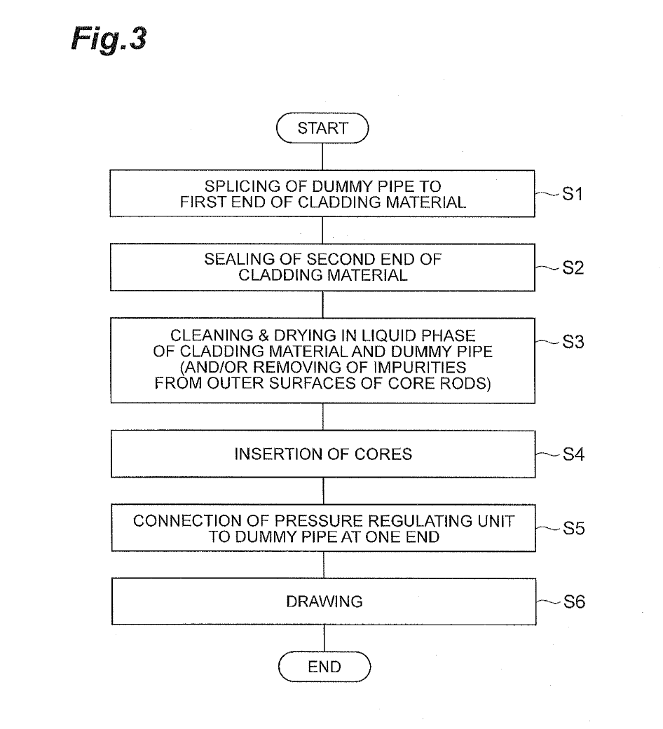

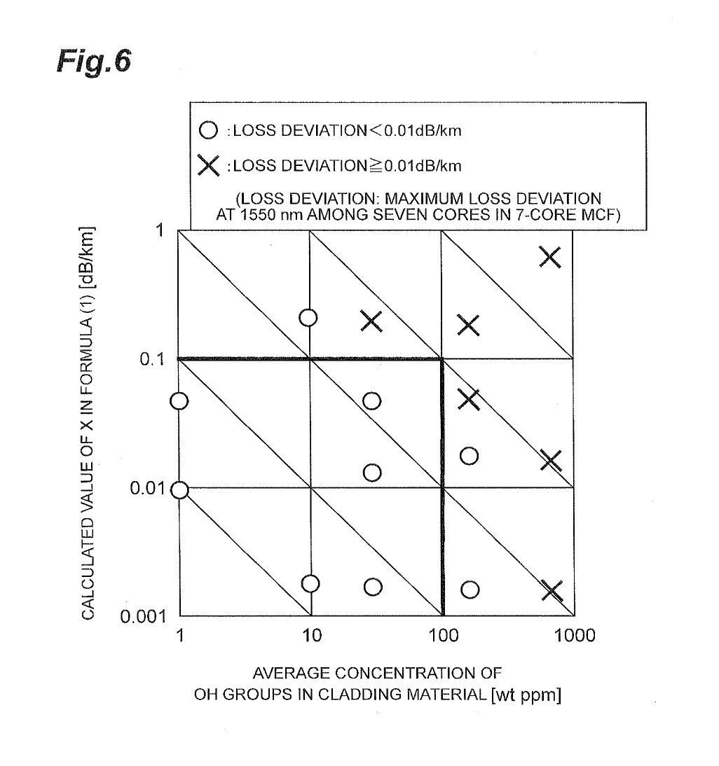

(2) As a second aspect applicable to the foregoing first aspect, preferably, the manufacturing method of the MCF further comprises: a profile measuring step of measuring refractive index profiles of the core rods; it is determined whether each of a plurality of core rods (candidates) satisfies Pj_{0.1}; and core rods (candidates) satisfying Pj_{0.1} are used as the core rods to be used in the inserting step. By controlling the leakage of optical power into the outer peripheries of the core rods in this manner, it is feasible to also fully suppress influence of absorption due to OH groups at the core rod interfaces (the core rod surfaces and the hole inner surfaces) and the impurities other than the OH groups. For this reason, even if the purifying process in vapor phase is not carried out for the inner surfaces of the holes in the cladding material or for the outer peripheral surfaces of the core rods, for example, as shown in FIG. 3 which will be described below, the deviation of transmission loss at the wavelength 1550 nm among cores can be kept not more than 0.01 dB/km as shown in FIG. 6, while the increase of transmission loss at the wavelength 1383 nm is kept not more than 0.1 dB/km. Namely, it becomes feasible to omit the purifying process in vapor phase. When the purifying process in vapor phase for the core rod interfaces is not carried out in the RID method, there is no need for supply facilities of gas for the purifying process; even in the case where the purifying process in vapor phase is carried out, it becomes unnecessary to equalize flow rates of gas for the purifying process flowing in the holes in the cladding material and over the outer peripheries of the cores, and thus the configuration of the drawing device and others can be simplified.

(3) As a third aspect applicable to at least either one of the first and second aspects, the insertion of the core rods can be performed after a sealing step of sealing the second end side of the cladding material, in the case where the foregoing manufacturing method of the MCF is used without the purifying process in vapor phase, because there is no need for flowing the gas for the purifying process between the core rods and the holes formed in the cladding material. In this case, the core rods can be inserted after the drawing start end (second end) is sealed. This allows the core rods to be readily prevented from dropping, without use of the core fixing member to prevent the dropping of the core rods.

(4) As a fourth aspect applicable to at least any one of the first to third aspects, preferably, the foregoing manufacturing method of the MCF further comprises: an impurity removing step (first impurity removing step) subsequent to the splicing step, the impurity removing step being a step of immersing the cladding material and the dummy pipe spliced to the cladding material, in at least one of an aqueous solution containing hydrogen fluoride and an aqueous solution containing hydrogen chloride. In this case, while the impurities such as OH groups can diffuse and adhere to the inner surfaces of the holes in the cladding material in the splicing step of splicing the dummy pipe to the first end side of the cladding material and in the step of sealing the one end of the cladding material, the impurities can be removed by execution of the above impurity removing process, whereby the MCF can be obtained with a lower transmission loss. It is also feasible to suppress generation of bubbles at the core rod interfaces due to the impurities.

(5) As a fifth aspect applicable to at least any one of the first to fourth aspects, the foregoing manufacturing method of the MCF may further comprise: a sealing step of splicing the cladding material to a sealing member used for sealing the second end side of the cladding material; and at least one of the splicing step and the sealing step may be configured as follows; a burning gas or an atmosphere in a heating furnace as a heat source to be used for melting or joining each member does not contain hydrogen or any hydrogen compound. In this case, when the heat source not containing hydrogen or any hydrogen compound is used for the burning gas or for the atmosphere in the heating furnace, in the splicing step of splicing the dummy pipe to the first end side of the cladding material and in the sealing step of sealing the second end side of the cladding material, the diffusion of OH groups into the cladding material can be prevented, whereby the MCF can be obtained with a low transmission loss. Examples of suitably-applicable heat sources not containing OH groups include a plasma burner, a resistance furnace, an induction furnace, and so on.

(6) As a sixth aspect applicable to at least any one of the first to fifth aspects, preferably, the foregoing manufacturing method of the MCF further comprises: an impurity removing step (second impurity removing step) prior to the inserting step, the impurity removing step being a step of removing impurities from outer surfaces of the core rods by use of at least one of a mechanical method and a chemical method. In this case, the MCF can be obtained with a low transmission loss because the impurities are removed from the outer surfaces of the core rods before insertion.

(7) As a seventh aspect applicable to at least any one of the first to sixth aspects, preferably, outer surfaces of the core rods have roughness Ra (conforming to “arithmetic mean roughness (Ra)” of Japanese Industrial Standards JIS B0601) of not more than 10 μm. When the difference between the outer diameter of the core rods and the inner diameter of the holes in the cladding material is small, adhesion proceeds without sufficient smoothing of the interfaces during fiber drawing and thus bubbles are likely to be generated. Then, when the roughness Ra of the outer surfaces of the core rods is not more than 10 μm as described above, the generation of bubbles can be suppressed. More preferably, the roughness Ra is not more than 1 μm. The smoothing of the outer surfaces of the core rods can be implemented by a method of polishing the surfaces with grind stone having the fine grain sizes of not less than #500, whereby the surface roughness RA can be not more than 10 μm. The roughness of the outer surfaces of the core rods can also be reduced by preliminarily removing the impurities from the outer surfaces of the core rods and thereafter heating the surfaces with a waterless heat source such as a plasma burner.

(8) As an eighth aspect applicable to at least any one of the first to seventh aspects, a total weight of the cladding material and the core rods may be not less than 20 kg. According to one aspect of the present invention, the load can be vertically imposed on the splice plane between the dummy pipe and the cladding material. Furthermore, since the outer diameter of the core rods does not have to be made unnecessarily large, the connection area can be appropriately set between the dummy pipe and the cladding material and the large cladding material of not less than 20 kg can be used. The total weight is more preferably not less than 30 kg and still more preferably not less than 50 kg. With increase in the scale of the preform, the length of an unstable part of the MCF during increase of drawing speed can be made relatively shorter and therefore the drawing speed can be increased without degradation of economic efficiency. The drawing speed can be set not less than 1000 m/min, whereby the MCF can be obtained with high economic efficiency.

### DETAILS OF EMBODIMENT OF INVENTION

The embodiment of the invention will be described below in detail with reference to the accompanying drawings. The same elements will be denoted by the same reference signs in the description of the drawings, without redundant description. It should be noted that the present invention is by no means intended to be limited to the below-described examples presented by way of illustration but is intended for inclusion of all changes within the meaning and scope of equivalence to the scope of claims, as described in the scope of claims.

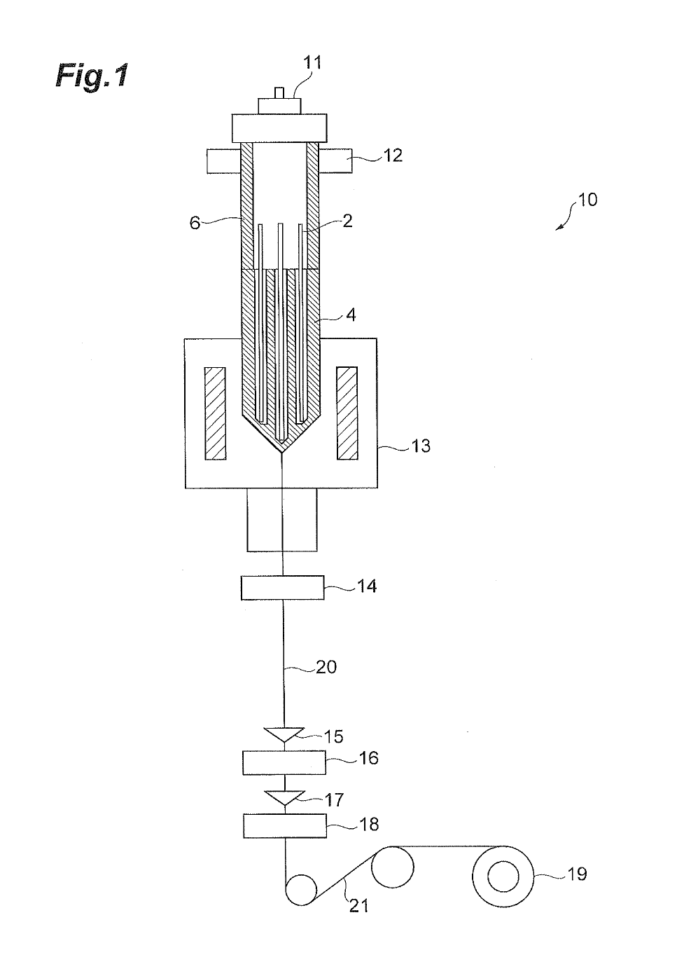

FIG. 1 is a drawing showing a configuration of a drawing device 10 used in the method for manufacturing the MCF according to the embodiment of the invention. The drawing device 10 has a pressure regulating unit 11, a holding unit 12, a thawing furnace 13, an outer diameter measuring unit 14, a first resin applying unit 15, a first UV (ultraviolet) irradiating unit 16, a second resin applying unit 17, a second UV irradiating unit 18, and a bobbin 19 as a winding mechanism. The drawing device 10 can manufacture the MCF 20 (21) by drawing core rods 2 and a cladding material 4 while heating them so as to integrate. The MCF 20 refers to an MCF before coated, and the MCF 21 to an MCF after coated.

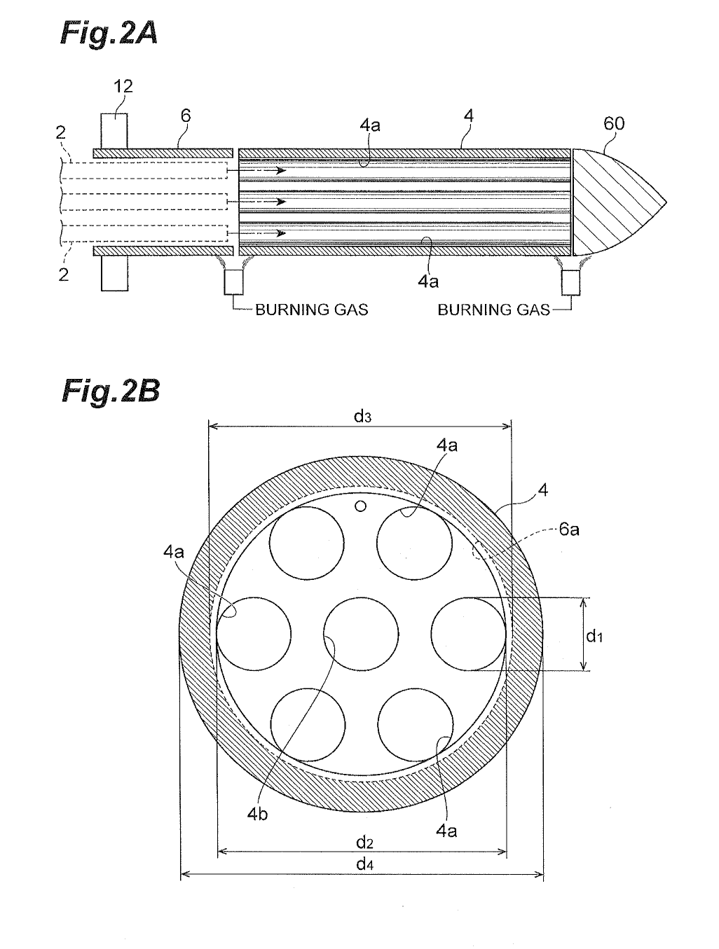

The method for manufacturing the MCF according to the embodiment of the invention is configured to sequentially perform a cladding material preparing step, a core rod producing step, a hole making step, a splicing step (step S1), a sealing step (step S2), an impurity removing step (step S3), an inserting step (step S4), a pressure regulating unit connecting step (step S5), and a drawing step (step S6), thereby manufacturing the MCF 20 (21) (cf. FIG. 3). The cladding material preparing step and the hole making step are steps of preparing a glass rod with a predetermined diameter d4 and making a plurality of holes 4a, 4b (cf. FIG. 2B) extending in the axial direction in the glass rod, thereby producing the cladding material 4. The foregoing manufacturing method may be configured as follows: it further has a profile measuring step of measuring refractive index profiles of the respective core rods 2; and the core rod producing step includes determining whether each of the core rods 2 can satisfy a below-described predetermined condition (optical power ratio Pj_{0.1}), and using the core rods satisfying this condition. Furthermore, the processing of the core rods 2 is carried out by stretching or by grinding of outer periphery (mechanical grinding or chemical etching) such that the outer diameter of the core rods becomes an appropriate value. The average concentration of OH groups in the core rods 2 is preferably less than 0.001 weight ppm and the average concentration of OH groups in the cladding material 4 is preferably less than 100 weight ppm. It is noted that the impurity removing step (step S3) can be omitted as long as cleanliness is maintained at a certain level for the outer peripheries of the core rods and the inner surfaces of the holes in the cladding material.

Next, the splicing step (step S1) is a step of splicing a dummy pipe 6 to the first end side (the left end side in the drawing) of the cladding material 4, as shown in FIG. 2A. In this regard, as shown in FIG. 2B, the diameter d3 of an inner periphery 6a of the dummy pipe 6 is made larger than the diameter d2 of a circumscribed circle around the plurality of holes 4a (satellite cores) formed in the cladding material 4.

Next, the sealing step (step S2) is a step of sealing the second end side opposite to the first end of the cladding material 4 by splicing a sealing member 60 to the second end side by heating or the like (cf. FIG. 1 and FIG. 2A). This sealing step can prevent the core rods 2 to be inserted thereafter, from dropping. In FIGS. 2A and 2B, the cladding material 4 and others are illustrated in horizontal arrangement, for easier description, but they are arranged in the vertical direction as shown in FIG. 1, during execution of fiber drawing.

At least one of the foregoing splicing step and sealing step may be configured so as not to use hydrogen or any hydrogen compound in a burning gas or in an atmosphere in a heating furnace as a heat source to be used for melting or joining each member In this case, the splicing step or the sealing step is arranged to use the heat source not containing hydrogen or any hydrogen compound, for the burning gas or the atmosphere in the heating furnace, whereby OH groups are prevented from diffusing into the cladding material 4, so as to achieve the aforementioned OH group concentration and thus obtain the MCF with a low transmission loss. Examples of suitably-applicable heat sources not containing OH groups include a plasma burner, a resistance furnace, an induction furnace, and so on.

Next, the cladding material 4 and the dummy pipe 6 spliced in the splicing step are immersed in a liquid phase being at least one of an aqueous solution containing hydrogen fluoride and an aqueous solution containing hydrogen chloride, to be cleaned and dried, so as to remove impurities (step S3). This impurity removing step can remove the impurities such as OH groups adhering to the inner surfaces of the holes 4a, 4b in the cladding material 4 and to the dummy pipe 6 and others in the splicing step and the sealing step, whereby the MCF can be obtained with a low loss. In addition, it can also suppress the generation of bubbles at the core rod interfaces due to the impurities. This impurity removing step may be configured to remove the impurities from the outer surfaces of the core rods 2 by use of at least one of a mechanical method and a chemical method. When the impurities are removed from the outer surfaces of the core rods 2 before insertion, the MCF can be obtained with a lower transmission loss.

Next, the inserting step (step S4) is a step of inserting the core rods 2 into the respective holes 4a, 4b in the cladding material 4. After completion of the insertion of the core rods 2, the pressure regulating unit 11 for adjustment of pressure is connected to one end side of the dummy pipe 6, as shown in FIG. 1 (step S5). Thereafter, the drawing step (step S6) is carried out to heat the second end side (lower end side) of the cladding material 4 by the drawing furnace 13 and draw the cladding material 4 and the core rods 2 so as to integrate, thereby manufacturing the MCF 20. The drawing device 10 is used in the drawing step out of these steps.

The details of the drawing step are as follows. The dummy pipe 6 is held by the holding unit 12, so that the cladding material spliced to this dummy pipe 6 and the core rods 2 inserted in the respective holes 4a, 4b in the cladding material 4 are arranged vertically in the drawing furnace 13. The atmosphere and pressure inside the holes 4a, 4b of the cladding material 4 are regulated by the pressure regulating unit 11 at the top of the dummy pipe 6 and the lower end side of the cladding material 4 and the core rods 2 is heated by the drawing furnace 13, whereby the cladding material 4 and the core rods 2 are drawn so as to integrate, thereby manufacturing the MCF 20.

The MCF 20 drawn out from the lower end of the drawing furnace 13 is then subjected to measurement of the outer diameter thereof by the outer diameter measuring unit 14, coated with a primary resin by the first resin applying unit 15, irradiated with UV by the first UV irradiating unit 16 to cure the primary resin, coated with a secondary resin by the second resin applying unit 17, and irradiated with UV by the second UV irradiating unit 18 to cure the secondary resin, whereby it turns into the MCF 21 with coatings of the two resin layers, to be wound onto the bobbin 19. The drawing speed or the like is adjusted based on the result of the outer diameter measurement by the outer diameter measuring unit 14, whereby the MCF 20 (21) can be manufactured with a desired cladding diameter.

The roughness Ra of the outer surfaces of the core rods 2 used in the foregoing manufacturing method is preferably not more than 10 μm. When the outer diameters of the core rods 2 and the inner diameters of the holes 4a, 4b in the cladding material 4 are small, adhesion between them proceeds before the interfaces between them become well smoothed during the fiber drawing process; therefore, bubbles are likely to be generated there. When the roughness Ra of the outer surfaces of the core rods 2 is kept not more than 10 μm, the generation of bubbles can be suppressed. More preferably, the roughness Ra of the outer surfaces is not more than 1 μm. The smoothing of the outer surfaces of the core rods 2 can be implemented by use of a method of polishing the surfaces by grind stone with fine grain sizes of not less than #500, thereby achieving the surface roughness Ra of not more than 10 μm. The roughness of the outer surfaces of the core rods can also be reduced by preliminarily removing impurities from the outer surfaces of the core rods 2 and thereafter heating the surfaces with a waterless heat source such as a plasma burner.

The MCF 20 (21) manufactured as described above is preferably compliant with ITU-T International Standard G.652.D. The MCF 20 (21) preferably has the bending loss property further compliant with G.657.A1, G657.A2, and G.657.133. With this, the MCF 20 (21) can be spliced to a general-purpose single-mode optical fiber compliant with G.652.D, with a low loss and can be handled in the same manner as the G.652.D optical fiber on a transmission system.

Each of the cores in the MCF 20 (21) can have a refractive index structure that can be contemplated by those skilled in the art, to set the transmission characteristics including crosstalk between cores and confinement loss to appropriate values, e.g., the step type, GI type, W type, and trench type. Design guides to properly set the crosstalk between cores and the confinement loss of the MCF 20 (21) are theoretically clarified (e.g., as to the crosstalk between cores, reference is made to Optics Express Vol. 19, No. 17, pp. 16576-16592, 15 August, 2011).

The propagation constants of the respective cores in the MCF 20 (21) may be equal to each other or may be different from each other. The number of propagation modes propagating in each core in the MCF 20 may be one, or, may be two or more.

Each core of the MCF 20 (21) is comprised of silica-based glass consisting primarily of SiO₂. A cladding portion constituting a part of each core rod 2 is comprised of SiO₂ glass (silica-based glass) and may contain or not contain F (fluorine) or Cl (chlorine).

The core rods 2 are manufactured by a vapor-phase glass synthesis method such as VAD (Vapor-phase Axial Deposition), OVD (Outside Vapor Deposition), MCVD (Modified Chemical Vapor Deposition), or PCVD (Plasma-activated Chemical Vapor Deposition) over core portions. Furthermore, the core rods 2 may be provided each with a part of a cladding layer by a method selected from the VAD, OVD, MCVD, rod-in collapse method, and other methods similar to them.

The MCF 20 (21) is colored in its coating or in part of the coating as needed, is processed into secondary products such as optical cables, optical cords, or optical fiber ribbons, and can be used as a module product in which a connection component such as an optical connector for connection to another optical device is connected to the fiber as occasion may demand.

Now, it is noted that in the foregoing manufacturing method, the core rods are produced so as to have the predetermined core rod diameter with the use of J_{OH} indicative of the average concentration of OH groups in the cladding material 4 and the optical power ratio Pj of the part other than the part corresponding to the core rods 2, in the MCF 20 (21), in order to manufacture the MCF while achieving satisfactory transmission loss, core position accuracy, and mass productivity all together. This is based on the finding by the Inventors that these problems can be solved by satisfying Formula (1) below.

X=(62.6×J_{OH} (weight ppm)+1175)×Pj (1)

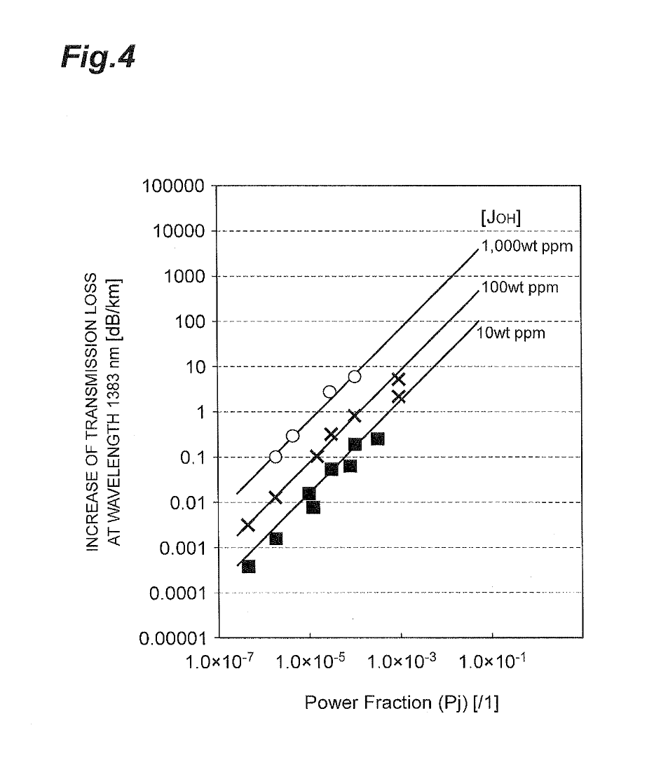

Now then, this point will be described below with reference to FIGS. 4 to 6.

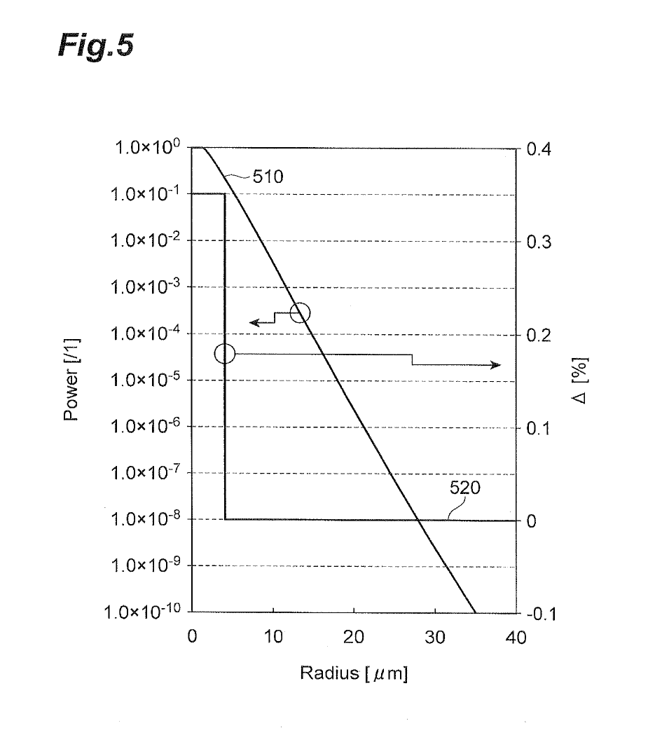

FIG. 4 is a drawing showing increase of transmission loss at the wavelength 1383 nm against optical power ratio Pj. The foregoing Formula (1) was calculated from linear relations at respective levels of J_{OH} (weight ppm) in FIG. 4. FIG. 5 is a drawing showing radius dependence of refractive index profile and optical power. FIG. 6 is a drawing showing a relation of loss deviation among seven cores at the wavelength 1550 nm with average concentration of OH groups in the cladding material and value of X in the foregoing Formula (1) for each MCF, where each MCF was manufactured with seven cores. In FIG. 6, “◯” represents a case where the deviation of transmission loss at the wavelength 1550 nm among seven cores is less than 0.01 dB/km, and “x” a case where the deviation is not less than 0.01 dB/km. In cases of cladding materials with smaller J_{OH}, there is a possibility that a solution can exist even in the region of X>0.1. The advantage of the manufacturing method according to the embodiment of the invention over the conventional technologies is that, even without the purifying process in vapor phase for the core rod interfaces (core rod surfaces and hole surfaces), the deviation of transmission loss at the wavelength 1550 nm among the cores can be kept not more than 0.01 dB/km as shown in FIG. 6, while the increase of transmission loss at the wavelength 1383 nm is kept not more than 0.1 dB/km. However, the purifying process in vapor phase may be carried out as described above, but, when it can be omitted, it is possible to reduce cost by suppression of additional facility investment and by omission of step.

FIG. 4 shows the increase Δα1.383 of transmission loss at the wavelength 1383 nm (corresponding to “X” in Formula (1)) due to the OH group amount J_{OH} in the cladding 4 against the optical power ratio Pj. As a result of multivariate analysis, let Pc be the optical power of signal light propagating inside core-rod-portion-equivalent portions corresponding to the core rod radius R in an optical fiber “after the drawing step,” and Pj be a rate of power of signal light at the wavelength 1383 nm propagating in an outer part (cladding-material-equivalent portion) outside the core-rod-portion-equivalent portions. Here, the optical power ratio Pj is a ratio of optical power except for the core-rod-portion-equivalent portions when the entire optical power of the cores and cladding is 1. It is noted that the optical power ratio Pj can be readily calculated by calculation from the refractive index profiles by those skilled in the art. The refractive index profiles to be used in the calculation can be measured for the manufactured optical fiber by the RNFP (refractive near field pattern) method. The interfaces of the core rods can be determined by use of various methods and can be defined, for example, by composition analysis in a cross section of the fiber.

FIG. 5 shows an example of radius dependence P(r) of optical power 510 on the assumption of the step type refractive index profile 520. In the step type refractive index profile 520 shown in FIG. 5, a relative refractive index difference Δ of core portion with respect to cladding, is 3.5%. The optical power ratio Pj can be calculated by use of Formula (2) below.

$$Pj = \frac{{\int }_{{r}_{corerod}}^{∞} P ( r ) r d r}{{\int }_{0}^{∞} P ( r ) r d r} \qquad ( 3 )$$

Here, r represents the radius of the fiber after drawn, and r_{corerod} the radius of the core rods in the fiber after drawn. The integration range ∞ for radius can be a radius where the optical power in the fiber is regarded as substantially zero, and it can be, for example, a radius where a change of Pj with expansion of the integration range becomes not more than 10⁻⁷.

In this manner, the foregoing manufacturing method further has: the Pj calculating step of calculating Pj_{0.1} (i.e., Pj in the case of X=0.1) to make X=(62.6×J_{OH} (weight ppm)+1175)×Pj=0.1 in Formula (1), where Pj is the optical power ratio at the wavelength 1383 nm of the part other than the core rods 2 in the optical fiber after drawn in the drawing step; and the P_{cc} calculating step of calculating P_{cc0.1} (i.e., P_{cc} in the case of X=0.1) to obtain Pj_{0.1} that can be calculated from the refractive index profiles of the core rods, where P_{cc} is the ratio of the outer diameter of the core rods/the diameter of the core portions, which is the ratio of the outer diameter of the core rods to the diameter of the core portions. In the core rod producing step, the core rods are processed so as to satisfy the condition that the ratio P_{cc} is not less than the ratio P_{cc0.1} and so as to have the core rod diameter 2R_{0.1}, where 2R is the core rod diameter which is set while the relation between the predetermined outer diameter of the optical fiber after drawn and the predetermined core diameter corresponds to the relation between the outer diameter of the cladding material and the diameter of the core portions of the core rods. By this manufacturing method, the thickness of the cladding portions in the core rods can be properly set while suppressing the increase of transmission loss and the deviation of transmission loss among cores.

In the foregoing manufacturing method, when the difference between the outer diameter of the core rods 2 and the inner diameter of the holes 4a, 4b in the cladding material 4 (clearance C) is set small, the creation accuracy of the core positions in the created MCF can be enhanced by that degree and the longitudinal variation of the core positions can also be suppressed. The clearance C may be large if the cladding material is large; however, it will increase influence of deformation of the holes 4a, 4b and, therefore, the clearance C is preferably not more than 1.5 mm. It is contemplated, however, that if the clearance C is too small, friction will occur between the core rods 2 and the inner surfaces of the holes 4a, 4b during insertion, so as to generate scratches on the inner surfaces of the holes 4a, 4b in the cladding material 4 and on the outer peripheries of the core rods 2; therefore, the clearance C is preferably not less than 0.15 mm. If there is longitudinal variation in the outer diameter of the cladding material 4, high set position accuracy of the cores cannot be achieved. A longitudinal variation amount of the outer diameter in an effective portion of the cladding material 4 is preferably not more than 1%. It is more preferably not more than 0.5%. The effective portion of the cladding material 4 is a portion not including end portions of the cladding material 4 that are variable in an outer diameter at beginning and ending of drawing.

When the clearance C is set small as described above, the set position accuracy of the cores in the MCF after drawn can be readily set to be less than 1 μm and preferably less than 0.5 μm. For the same reason, a longitudinal bend amount of the holes 4a, 4b made in the cladding material 4 is desirably as small as possible. A longitudinal variation amount of the center positions of the holes 4a, 4b in the cladding material 4 with respect to the center on the axis of the cladding material 4 is desirably not more than 1% and more preferably not more than 0.5%. Since the clearance C is not more than 1.5 mm, the creation accuracy of the core positions in the MCF 20 (21) can be enhanced and the longitudinal variation of the core positions can also be suppressed.

As described above, the manufacturing method of the MCF according to the embodiment of the invention can manufacture the MCF while achieving the satisfactory transmission loss, core position accuracy, and mass productivity all together.

Namely, the present invention has successfully provided the method for manufacturing the MCF with excellent economic efficiency and productivity and with a low transmission loss.

What is claimed is:

1. A method for manufacturing a multi-core optical fiber, comprising:
a cladding material preparing step of preparing a cladding material comprised of silica-based glass and having an average concentration J_{OH} of OH groups less than a predetermined concentration;
a core rod producing step of producing a plurality of core rods comprised of silica-based glass and each having a core portion and a part of a cladding;
a hole making step of making a plurality of holes in the cladding material so as to extend along an axial direction thereof;
a splicing step of splicing a dummy pipe to a first end side of the cladding material;
an inserting step subsequent to the splicing step, the inserting step being a step of inserting the plurality of core rods into the respective holes in the cladding material; and
a drawing step subsequent to the inserting step, the drawing step being a step of integrating the cladding material and the core rods and drawing a thus-integrated part thereof while heating a second end side of the cladding material, thereby drawing the cladding material and the core rods into the multi-core optical fiber,
wherein an average concentration of OH groups in each of the core rods prepared is less than 0.001 weight ppm and said J_{OH} is less than 100 weight ppm,
the method comprising: a Pj calculating step of calculating Pj_{0.1} (Pj in the case of X=0.1) satisfying X=(62.6×J_{OH} (weight ppm)+1175)×Pj=0.1, where Pj is an optical power ratio at the wavelength 1383 nm of a portion corresponding to the cladding material in the multi-core optical fiber after drawn; and a P_{cc} calculating step of calculating P_{cc0.1} (P_{cc} in the case of X=0.1) to obtain said Pj_{0.1} that can be calculated based on a core rod refractive index profile, where P_{cc} is a ratio of an outer diameter of the core rods to an outer diameter of the core portions (the outer diameter of the core rods/the outer diameter of the core portions),
wherein the core rod producing step comprises processing the core rods so as to satisfy the condition that the ratio P_{cc} is not less than the ratio P_{cc0.1} and so as to make each of the core rods have a core rod diameter 2R_{0.1} (2R in the case of P_{cc}≧P_{cc0.1}), where 2R is the outer diameter of the core rods whose core portions are configured so that a predetermined relation between an outer diameter of cores and an outer diameter of the multi-core optical fiber after drawn corresponds to a relation between the outer diameter of the cladding material and the outer diameter of the core portions, and
wherein the hole making step comprises processing the plurality of holes in a range where C is not less than 0.15 mm and not more than 1.5 mm, where a hole diameter of the plurality of holes formed in the cladding material is the core rod diameter 2R_{0.1}+C.

2. The method according to claim 1, further comprising:
a profile measuring step prior to the core rod producing step, the profile measuring step being a step of measuring refractive index profiles of the core rods,
wherein the core rod producing step comprises: determining whether each of a plurality of core rod candidates produced satisfies said Pj_{0.1}; and using core rod candidates satisfying said Pj_{0.1} out of the plurality of core rod candidates, as the plurality of core rods.

3. The method according to claim 1, further comprising:
a sealing step prior to the inserting step, the sealing step being a step of sealing the second end side of the cladding material.

4. The method according to claim 1, further comprising:
a first impurity removing step subsequent to the splicing step, the first impurity removing step being a step of immersing the cladding material and the dummy pipe spliced to the cladding material, in at least one of an aqueous solution containing hydrogen fluoride and an aqueous solution containing hydrogen chloride.

5. The method according to claim 1, further comprising:
a sealing step prior to the inserting step, the sealing step being a step of splicing the cladding material to a sealing member used for sealing the second end side of the cladding material,
wherein in at least one of the splicing step and the sealing step, a burning gas or an atmosphere in a heating furnace as a heat source to be used for melting or joining each member does not contain hydrogen or any hydrogen compound.

6. The method according to claim 1, further comprising:
a second impurity removing step prior to the inserting step, the second impurity removing step being a step of removing impurities from outer surfaces of the respective core rods by use of at least one of a mechanical method and a chemical method.

7. The method according to claim 1, wherein outer surfaces of the respective core rods have roughness Ra of not more than 10 μm.

8. The method according to claim 1, wherein a total weight of the cladding material and the plurality of core rods is not less than 20 kg.
